(19) United States
(12) Patent Application Publication
(10) Pub. No.: US 2025/0240292 A1
(43) Pub. Date: Jul. 24, 2025

(54) COMPUTER NETWORKING DEVICE SHELL ACCESS VIA CLOUD-BASED AUTHORIZER

(71) Applicant: Ruckus IP Holdings LLC, Claremont, NC (US)

(72) Inventors: Renjith Kumar Ponnappan, Fremont, CA (US); Nikhil Bhatia, San Jose, CA (US)

(21) Appl. No.: 19/032,572

(22) Filed: Jan. 21, 2025

Related U.S. Application Data
(60) Provisional application No. 63/623,896, filed on Jan. 23, 2024.

(51) Int. Cl. H04L 9/40

(52) U.S. Cl. CPC H04L 63/0876; H04L 63/0838; H04L 63/108

(57) ABSTRACT

Devices, systems, and methods for connecting to computer networking devices securely to perform commands thereon. For example, a method according to the present disclosure may include: receiving a request to register a first device identifier that is associated with a computer networking device; generating a token; associating the generated token with the first device identifier; generating a one-time password that secures the generated token; transmitting the generated one-time password that secures the generated token; receiving a request for the token from a computer networking device, the request including a second device identifier, the second device identifier identifying the computer networking device; comparing the second device identifier with the first device identifier; and providing the token to the computer networking device if the second device identifier matches the first identifier.

### CROSS-REFERENCE TO RELATED APPLICATION

This application claims priority to U.S. Provisional Patent Application No. 63/623,896, filed on Jan. 23, 2024, the contents of which are incorporated herein by reference in its entirety.

### TECHNICAL FIELD

The present disclosure relates to computer networking devices, and in particular relates to devices, systems, and methods for connecting to computer networking devices securely to perform commands thereon.

### BACKGROUND

Computer networking devices, such as switches, routers and/or access points, typically operate using software that resides in memory and is executed by one or more processors of the computer networking devices. This software often includes application software that has one or more program modules written by software developers to provide specific higher-level functionality for the computer networking device. Examples of such higher-level functionality provided by application software can include: connecting to or establishing a Layer-2 or Layer-3 network, facilitating packet or datagram transfer over the established network, and/or providing a user interface.

The software for computer networking device also typically includes a lower-level operating system, which may manage and facilitate interaction with hardware components, memory allocation and control, input and output, and so on. Operating systems typically employ a kernel, which may be a central program having complete or nearly complete control over the hardware, such as the central processing unit and memory. The operating system also includes other software components, such as libraries that contains various lower-level functions and programs that can be accessed and/or executed by users or application software. During operation, the application software performs system calls (e.g., via an Application Programming Interface (API)) to the operating system kernel and/or to other components of the operating system to request that the hardware perform a task, such as retrieve data from a memory location, have the CPU perform a calculation or data manipulation, transmit data to a destination, and so on. In some instances, vendors or manufacturers of computer networking devices may employ device-specific operating systems, while in other instances, vendors or manufacturers may employ an operating system sold or offered by a software company or community. Common operating systems include Microsoft Windows, MacOS, Unix, and Linux. Such operating systems may be customizable or configurable to fit specific needs. For example, most Linux distributions (e.g., Ubuntu) include a Linux kernel and various “core” libraries and tools, as well as package management software that enables a user or administrator to retrieve and install software packages that provide additional functionality.

One program offered as a core part of an operating system is a shell program. The shell program can include a graphical user interface (GUI) and/or a command line interface (CLI). Unix- and Linux-based examples of shell programs include sh (Bourne shell), bash (Bourne Again Shell) and Z shell (zsh). A shell program can receive user input in the form of executable command statements and use kernel resources, such as the kernel API, to process the user input and provide output. The shell program may also be configured to receive a file script storing commands. Many, if not all, files, programs, or functions that are present in the memory of the computer may be instantiated or accessed from the command line interface or shell program.

### BRIEF DESCRIPTION OF THE FIGURES

FIGS. 1A and 1B are block diagrams illustrating some aspects of computer networking devices according to some embodiments of the present disclosure.

FIG. 2 is a block diagram illustrating electronic devices and computer networking devices in a network according to some embodiments of the present disclosure.

FIG. 3 is a block diagram illustrating some aspects of computer networking devices according to some embodiments of the present disclosure.

FIG. 4 is a block diagram illustrating some aspects of computer networking devices and a shell access authorizer according to some embodiments of the present disclosure.

FIG. 5 is a communication diagram illustrating aspects related to registering a device with a shell access authorizer and generating authorization credentials, according to some embodiments of the present disclosure.

FIGS. 6A and 6B are communication diagrams illustrating aspects related to retrieving authorization credentials via a limited command set shell program to access an access-limited full command set shell program, according to some embodiments of the present disclosure.

FIG. 7 is a flow diagram illustrating aspects related to registering a device with a shell access authorizer and generating and providing authorization credentials, according to some embodiments of the present disclosure.

FIG. 8 is a flow diagram illustrating aspects related to retrieving authorization credentials via a limited command set shell program to access an access-limited full command set shell program, according to some embodiments of the present disclosure.

FIG. 9 is a block diagram illustrating an example of an electronic device according to some embodiments of the present disclosure.

Note that like reference numerals refer to corresponding parts throughout the drawings. Moreover, multiple instances of the same part are designated by a common prefix separated from an instance number by a dash.

### DETAILED DESCRIPTION

Computer networking devices, such as access points, switches, and routers, may be specific-purpose devices, and the application software installed thereon may be specific-purpose as well. Developers of application software for computer networking devices may desire to limit or disable some functionality of the operating system that might be provided or made available in other situations, such as for general-purpose computing devices (e.g., personal computers), because the functionality is not needed in the normal or typical operation of the computer networking device. For example, software developers may want to disable the package management software that permits a user or administrator to retrieve and install software packages that provide additional functionality, because the additional functionality is not needed or desired in the operation of the computer networking device. As another example, application software developers may want to limit read access to their application software to avoid unauthorized reading and/or copying of system software. As yet another example, application software developers may want to limit a user's ability to write or alter files present on the computer networking device and prevent inadvertent or malicious changes to the functionality of the computer networking device.

One way to limit or disable some of the functionality of the operating system may be to employ an access rights and/or permissions scheme offered by a component of the operating system. In such a scheme, users and/or programs may be assigned permissions or bundles of permissions that authorize (or prohibit) read, write, and/or execute operations on files or other programs. Typically, even in such schemes there is a required root user or other superuser who is provided with system-wide permission to read, write, and execute all files and programs. Using permissions/access rights schemes can be effective, but may require careful and ongoing attention to avoid having a user or program with too many (or too few) permissions. The availability of the root user or superuser with system-wide access may also present a malicious user with an opportunity to exploit such system-wide permissions and a way to tamper, disable, and/or alter functionality of a computer networking device.

Another way to limit or disable some of the functionality of the operating system in computer networking devices may be to not install the core shell program on the computer networking device. As discussed above, many files, programs or functions that are present in the memory of the computer may be instantiated or accessed from the core shell program. Not installing the shell program can therefore, in theory, disable access to many of the files, programs and functions. This may in turn reduce or eliminate inadvertent or malicious accessing and manipulating of files present on the computer networking device, thereby improving performance, stability, and security of the computer networking device.

As part of a software development process for a computer networking device, the operating system and device-specific application software for the computer networking device may be bundled together into a single production build that is written into a memory of the computer networking device prior to or immediately after assembly of the computer networking device. For example, the production build may be loaded onto nonvolatile memory devices that are to be installed into the computer networking device prior to the assembly of the computer networking device. The production build may include a customized or configured version of the operating system in which no core shell program is present. Instead, the production build may be configured such that the device-specific application software is the only executable program present on the computer networking device that has access to the operating system kernel (e.g., via the kernel API). The device-specific application software may be initialized by a startup daemon or process during a startup or boot sequence of the computer networking device. In some embodiments where a core shell program is not installed with the operating system, the device-specific application software may provide a device-specific shell (GUI and/or CLI) in which a subset of operating system commands or resources are accessible. This may enable the device-specific application software to act as a “walled garden” and reduce or eliminate the inadvertent or malicious tampering, disabling, and/or altering of the software and files present on the computer networking device.

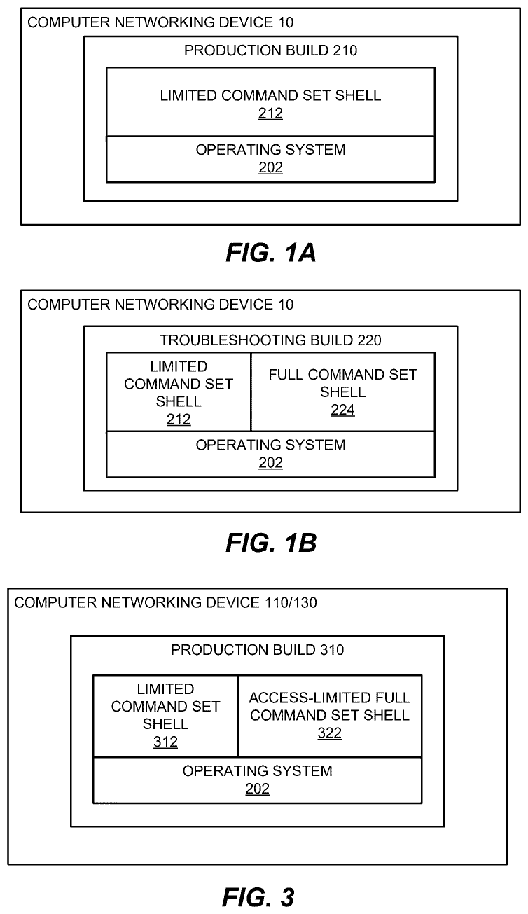

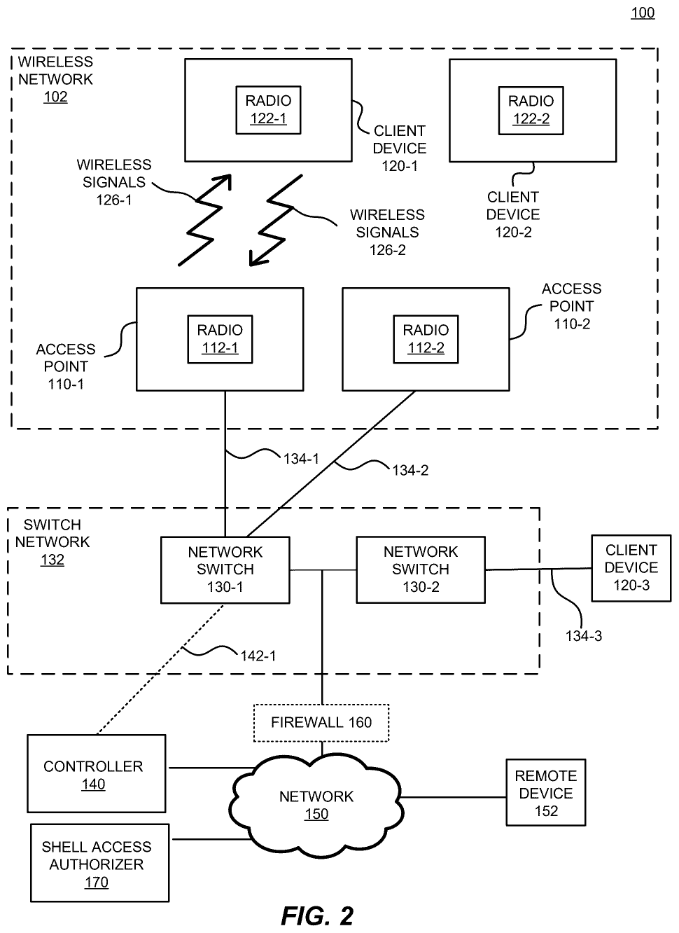

FIG. 1A is a block diagram illustrating that for an example computer networking device 10, such as an access point or a network switch (described in greater detail below with reference to FIG. 2), a production software build 210 (e.g., a final release version of software for the computer networking device) may include an operating system 202 and application software providing only a limited command set shell program 212. The limited command set shell program may process access only to a set of commands that are needed during the normal operation of the computer networking device 10. This limited command set shell program 212 may be written specifically for the production software build 210, or may be a customized or specially-configured version of a shell program.

Although the production software build 210 and the limited command set shell program 212 thereof may provide acceptable access to operating system resources when working properly, there may be instances where a computer networking device 10 does not work properly in a production environment. For example, a computer networking device 10 may be misconfigured, may exhibit poor performance, and/or may not communicate properly with other devices present in a production networking environment. Diagnosis and/or resolution of some issues may require access to various components of the operating system or other software, hardware, or firmware present on the computer networking device.

A limited command set shell program 212 of a production build 210 may lack appropriate commands to diagnose and/or resolve such issues. One troubleshooting workflow may be to install a temporary troubleshooting software build on the computer networking device 10. For example, FIG. 1B shows a troubleshooting software build 220, which may be installed for a limited time on the computer networking device 10 by a debugging or troubleshooting software engineer. The troubleshooting software build 220 may include the limited command line interface (CLI) or shell program 212 that provide access to a set of commands that are needed during the normal operation of the computer networking device, and may also provide a full command set shell (e.g., a core operating system shell program) 224 that may be used by the debugging or troubleshooting software engineer to diagnose and/or resolve a problem present in the computer networking device 10. As discussed above, the full command set shell 224 may provide a way to instantiate and/or access programs or functions that are present in the memory of the computer networking device 10, and may provide the debugging or troubleshooting software engineer a way to read, write, and/or execute programs or files.

Installing the troubleshooting build 220 on the computer networking device 10 may itself be challenging or difficult. The debugging or troubleshooting software engineer must arrange an appropriate time to access the computer networking device 10 with a customer or operator, which may be problematic when taking different locations, time zones, operating hours, or other factors into account. The troubleshooting build 220, because it is to be installed on the computer networking device 10 for only a limited period of time, may not employ an appropriate permissions scheme for permitting or prohibiting access to the full command set shell 224. Therefore, the debugging or troubleshooting software engineer must take great care to remove the troubleshooting build 220 and restore the production build 210 to avoid creating a potential vulnerability that may be used inadvertently or maliciously to alter the functionality of the computer networking device 10.

Pursuant to embodiments of the present disclosure, methods and systems are provided in which a production build may include both a limited command set shell program that provides access to a set of commands that are needed during the normal operation of the computer networking device, and may also provide an access-limited full command set shell program that may be used selectively to perform debugging or troubleshooting. Aspects of the present disclosure provide that, as part of a debugging or troubleshooting process, a computer networking device may register with a shell access authorizer. The shell access authorizer may generate authorization credentials, which may be retrieved via a command accessible via the limited command set shell program. The shell access authorizer may be a cloud-based authorizer. The authorization credentials may permit temporary access to the access-limited full command set shell program. This may in turn reduce or eliminate inadvertent or malicious accessing and manipulating of files present on the computer networking device, while also increasing a capability to perform troubleshooting and debugging of computer networking devices, thereby improving performance, stability, and security of the computer networking devices and the networks in which the computer networking devices operate.

Some aspects of the present disclosure are described in greater detail with respect to FIGS. 2-8. FIG. 2 is a block diagram illustrating electronic devices and computer networking devices in a network 100 according to some embodiments of the present disclosure. In the network 100, one or more access points 110 may communicate with client devices 120 in a wireless network 102, which may be a wireless local area network (WLAN). The access points 110 may be serviced by a switch network 132 that includes one or more network switches and/or routers 130, which may facilitate access to a network (e.g., an external network) 150. The access points 110 and network switches and/or routers 130 may be referred to herein collectively as computer networking devices 110/130. The network 100 may also include a controller 140, a remote device 152, a firewall 160, and a shell access authorizer 170. The network 100 may also include other computer networking devices (not shown) such as data planes or the like.

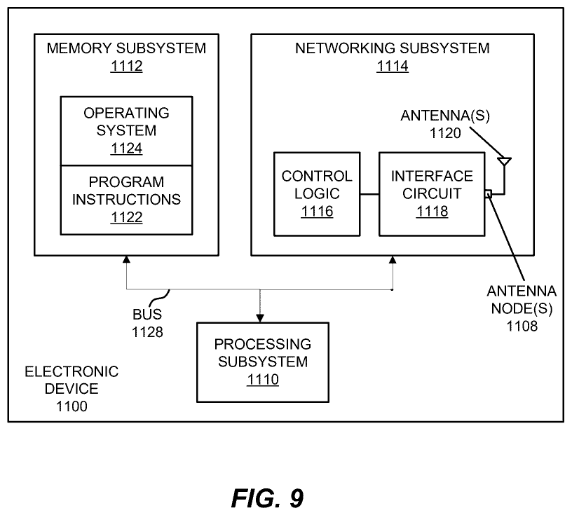

As described further below with reference to FIG. 9, the access points 110 and network switches 130 (which may be a group referred to herein as “computer networking devices 110/130” or “the one or more computer networking devices 110/130”) as well as the other devices illustrated in FIG. 2, such as the client devices 120, the controller 140, the firewall 160, the shell access authorizer 170, and the remote device 152 may include subsystems, such as a networking subsystem, a memory subsystem and a processor subsystem. More generally, the access points 110, network switches 130, client devices 120, and/or other devices can include (or can be included within) any electronic devices with the networking subsystems that enable the access points 110, network switches 130, client devices 120, and/or other devices to communicate with each other using wireless and/or wired communication.

The access points 110 may communicate using wireless and/or wired communication (such as by using Ethernet or a communication protocol that is compatible with Ethernet) with the client devices 120. Herein, wireless communication may include communication of packets or frames in accordance with a wireless communication protocol, such as an Institute of Electrical and Electronics Engineers (IEEE) 802.11 standard (sometimes referred to as ‘WiFi.’ In the discussion that follows, WiFi is used as an illustrative example. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Other wireless interfaces and/or protocols may be used, such as Bluetooth, and unless stated otherwise, the present disclosure is not limited to a particular wireless communication standard, interface, or protocol.

In some embodiments, the access points 110 may include physical access points and/or virtual access points that are implemented in software in an environment of an electronic device or a computer. In some embodiments, the access points 110 may communicate with each other via wired or wireless connections (e.g., via the switch network 132 or via wireless signals 126). The wired and/or wireless communication among access points 110 in wireless network 102 may occur via a network (such as an intra-net, a mesh network, point-to-point connections and/or the Internet) and may use a network communication protocol, such as Ethernet. In some embodiments, the access points 110 may be arranged in a mesh configuration, such as where a direct wired or wireless connection between an access point 110 and a network switch 130 of the switch network 132 is absent, and the access point 110 instead communicates indirectly with the switch network 132 and/or the network 150 via one or more intermediate access points 110.

As can be seen in FIG. 2, wireless signals 126-1 (represented by a jagged line) are transmitted from a radio 112-1 in access point 110-1. These wireless signals may be received by radio 122-1 in a client device 120-1. Wireless signals 126-2 (represented by a jagged line) are transmitted from the radio 122-1 in the client device 120-1. These wireless signals may be received by the radio 112-1 in the access point 110-1. Each of the radios 112 and 122 may be configured to generate and/or receive radio frequency signals in one or more wireless communication frequency bands (e.g., the 2.4 GHz frequency band, the 5 GHz frequency band, the 6 GHZ frequency band, and so on). Although only one radio 112/122 is shown in each of the access points 110 and client devices 120, it may be understood that in some embodiments multiple radios 112/122 may be present, each configured to generate and/or receive signals in different frequency bands.

Each of the client devices 120 may be, for example, any network-capable electronic device, including (as non-limiting examples) a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device. As seen in FIG. 2, some client devices 120 (e.g., client device 120-3) may not be part of the wireless network 102, and may instead be directly coupled with a network switch 130 of the switch network 132.

The switch network 132 may include one or more network switches and/or routers 130. In some embodiments, the one or more network switches and/or routers 130 may include a stack of multiple switches or routers (which are sometimes referred to as ‘stacking units’). As an example, a network switch 130-1 may include a number of communication interfaces or ports (not shown) in communication with one or more electronic devices. During operation, a first of the communication interfaces may receive a packet or other data container from a first electronic device (e.g., a client device 120, an access point 110, another networking switch 130). The packet may then be processed and forwarded to a second port associated with a second electronic device. The network switch and/or router 130 may be a layer-2 or layer-3 network switch or router. The switch network 132, and the network switches 130 thereof, may be coupled to access points 110 of the wireless network 102 via wired links 134.

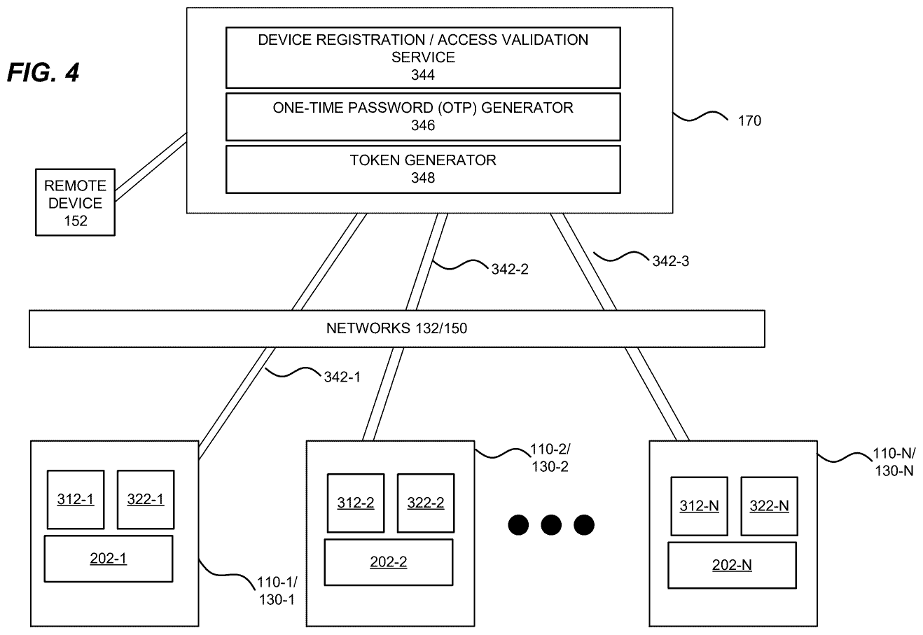

FIG. 3 is a block diagram illustrating some aspects of computer networking devices according to some embodiments of the present disclosure. As seen in FIG. 3, each of the computer networking devices 110/130 of FIG. 2 may include or have installed thereon a production software build 310, which may include an operating system 202, a limited command set shell 312, and an access-limited full command set shell 322. The limited command set shell program 312 may be similar to the limited command set shell 212 discussed above, with the limited command set shell program 312 providing access to a set of commands that are needed during the normal operation of the computer networking device. The access-limited full command set shell 322 may be used by a debugging or troubleshooting software engineer to diagnose and/or resolve a problem present in the computer networking device 110/130. The access-limited full command set shell 322 may provide a way to instantiate and/or access programs or functions that are present in the memory of the computer networking device 110/130, and may provide the debugging or troubleshooting software engineer a way to read, write, and/or execute programs or files. However, in contrast to the troubleshooting build 220 of FIG. 1B, the access-limited full command set shell 322 may be installed on the computer networking device 110/130 as part of the production build 310, and temporary access to the access-limited full command set shell 322 may be controlled in part by the shell access authorizer 170, described in greater detail below. The production software build 310 of FIG. 3 therefore permits operations in which troubleshooting and/or debugging of a computer networking device 110/130 without temporary installation of a troubleshooting software build 220, thereby improving the performance, security, and stability of the computer networking device 110/130.

Returning to FIG. 2, the controller 140 may be configured to perform configuration operations and/or management operations that control functionality of the computer networking devices 110/130. For example, the controller 140 may define flow definitions comprising packet processing rules and corresponding actions and promulgate these rules to the network switches 130 of the switch network 132. As another example, the controller 140 may manage the access points 110, for example by providing various configuration information, controlling settings, routing information, authorization/authentication information, or the like. The controller 140 may communicate with the access point 110 and/or network switches 130 via one or more logical links 142 (one of which is shown in FIG. 2 as logical link 142-1), which in some embodiments may at least partially overlap the wired links 134. The controller 140 may be configured to offer a single user interface accessible via a web browser, command prompt, or the like, via which control commands may be entered.

In some embodiments, the controller 140 may be connected via physical links with one or more of the access points 110 or the network switches 130 (and may be part of the switch network 132). In some embodiments, the controller 140 may be one of the network switches 130. In some embodiments, the controller 140 may be a cloud-based controller 140 that may be operating at a location relatively remote from the switch network 132 and the network switches 130 thereof. The cloud-based controller 140 may communicate with the network switches 130 via a network 150. The controller 140 may be configured to receive commands from a remote device 152, which in some embodiments may be a laptop computer or other device similar to a client device 120 that is operated by a network administrator to perform configuration of the network 100. In some embodiments, more than one controller 140 may be present in the network 100. In some embodiments, the network switches 130 may be at locations relatively remote from one another, and may communicate with each other via a network, such as the network 150.

The network 150 may be a layer-2 or layer-3 network, and may include one or more local area networks (LANs), campus area networks (CANs), wide area networks (WANs), metropolitan area networks (MANs), and/or the Internet. The network 150 may be separated from the switch network 132 by a firewall 160, which may monitor network traffic that is incoming to and outgoing from the switch network 132 and decide whether to permit or prohibit various traffic based on one or more security rules.

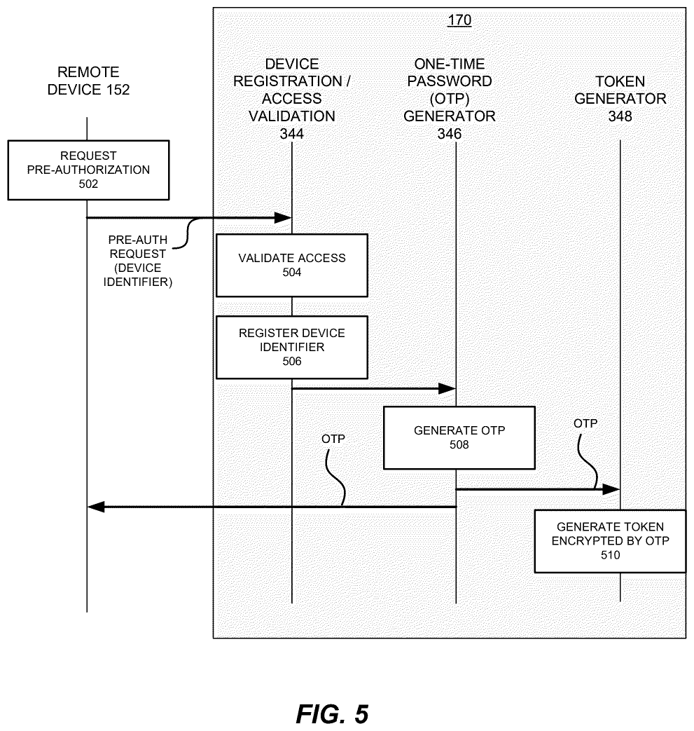

Also present in the network 100 of FIG. 2 may be a shell access authorizer 170, which may be configured to perform authorization operations and/or management operations that control access to functionality of the computer networking devices 110/130. FIG. 4 is a block diagram illustrating some aspects of the computer networking devices 110/130 and the shell access authorizer 170 according to some embodiments of the present disclosure. The shell access authorizer 170 may receive requests to register computer networking devices 110/130 with a device registration service. The shell access authorizer 170 may generate authorization credentials, which may be retrieved via a command that is part of the limited command set that is accessible via the limited command set shell program 312 installed on the computer networking devices 110/130 (e.g., that is part of the production build 310). The authorization credentials may permit temporary access to the access-limited full command set shell program 322 that is also installed on the computer networking devices 110/130 (e.g., that is also a part of the production build 310).

The shell access authorizer 170 may communicate directly with the access points 110 and/or network switches 130, and/or may communicate indirectly with the access points 110 and/or network switches 130 via the controller 140 (e.g., via the one or more logical links 142). The shell access authorizer 170 may communicate with the remote device 152. In some embodiments, the shell access authorizer 170 may be configured to offer interfaces to one or more components thereof, such as a Representational State Transfer (REST) API, which may be accessible via a web browser, command program, or the like. In some embodiments, the shell access authorizer 170 may be integrated with a cloud-based controller 140. In some embodiments, the shell access authorizer 170 may be a cloud-based authorizer.

As seen in FIG. 4, the shell access authorizer 170 may include a device registration and access validation service 344, a one-time password (OTP) generator 346, and a token generator 348. The device registration and access validation service 344 may be configured to receive a serial number or other identifier of a computer networking device as an input and store the received serial number or other identifier as part of a registration process. For example, as part of a troubleshooting or debugging workflow for a computer networking device 110/130, a user may request that access be granted to the access-limited full command set shell program 322 that is installed on the computer networking device 110/130. The user may be, for example, an administrator associated with the network in which the computer networking device 110/130 is located (e.g., the network 100) or may be a technical support specialist associated with a manufacturer, vendor, or operator of the computer networking device 110/130. The user may perform the request using one or more computer devices, such as the remote device 152.

In response to the request that access be granted to the access-limited full command set shell program 322 that is installed on the computer networking device 110/130, the computer networking device 110/130 may be registered with the device registration and access validation service 344. In other words, a request to register the computer networking device 110/130 with the device registration and access validation service 344 may be based on or in response to identifying a problem with the computer networking device 110/130 that requires debugging or troubleshooting. The request to register the computer networking device 110/130 with the device registration and access validation service 344 may include the serial number or other identifier of the computer networking device.

In some embodiments, other information may be obtained and provided to the device registration and access validation service 344 as part of a determination or decision-making process. For example, the device registration and access validation service 344 may receive account information, customer information, user information, network information, problem information (e.g., a customer support ticket, an identifier in a bug tracking database or project management database, etc.) and/or other information about the nature of the problem for which troubleshooting and debugging is sought. In some embodiments, the information provided to the device registration and access validation service 344 may include credentials associated with the administrator associated with the network in which the computer networking device 110/130, or the technical support specialist associated with a manufacturer, vendor, or operator of the computer networking device 110/130. The information provided to the device registration and access validation service 344 may be used to determine or decide whether to grant access to the access-limited full command set shell program 322 that is installed on the computer networking device 110/130.

If it is decided or determined that, for troubleshooting or debugging purposes, access should be granted to a debugging or troubleshooting user to the access-limited full command set shell program 322 that is installed on the computer networking device 110/130, the device registration and access validation service 344 may record the serial number or other device identifier of the computer networking device 110/130 in a database or data store associated therewith. The device registration and access validation service 344 (or another component of the shell access authorizer 170) may then invoke a process in which authorization credentials are generated to be used in accessing the access-limited full command set shell program 322 that is installed on the computer networking device 110/130.

The authorization credentials may be generated by the OTP generator 346 and the token generator 348. The OTP generator 346 may generate an OTP, which may be an alphanumeric sequence of characters that secures or encrypts a token generated by the token generator 348. In some embodiments, the alphanumeric sequence may be 32 characters in length.

The token generated by the token generator 348 may include parameters associated with a debugging or troubleshooting session using the access-limited full command set shell program 322 that is installed on the computer networking device 110/130. For example, the token may include an expiry, which may be a time after which the token is no longer valid and a debugging or troubleshooting session using the access-limited full command set shell program 322 may not be started and/or used. The token may include a duration, which may be an amount of time that a debugging or troubleshooting session using the access-limited full command set shell program 322 may last. As another example, the token may include a number of commands that may be performed during the debugging or troubleshooting session using the access-limited full command set shell program 322. Such parameters may ensure that a debugging or troubleshooting session using the access-limited full command set shell program 322 lasts only as long as is needed to perform debugging or troubleshooting. If the token has expired and/or a duration of the token has elapsed, then the access-limited full command set shell program 322 may not be accessed, and in some embodiments, a process using the access-limited full command set shell program 322 may be terminated or suspended. In some embodiments, the token may be or may include a JSON format, or JSON web token (JWT).

Although only one shell access authorizer 170 is shown in FIGS. 2 and 4, in some embodiments a plurality of shell access authorizers 170 may be provided.

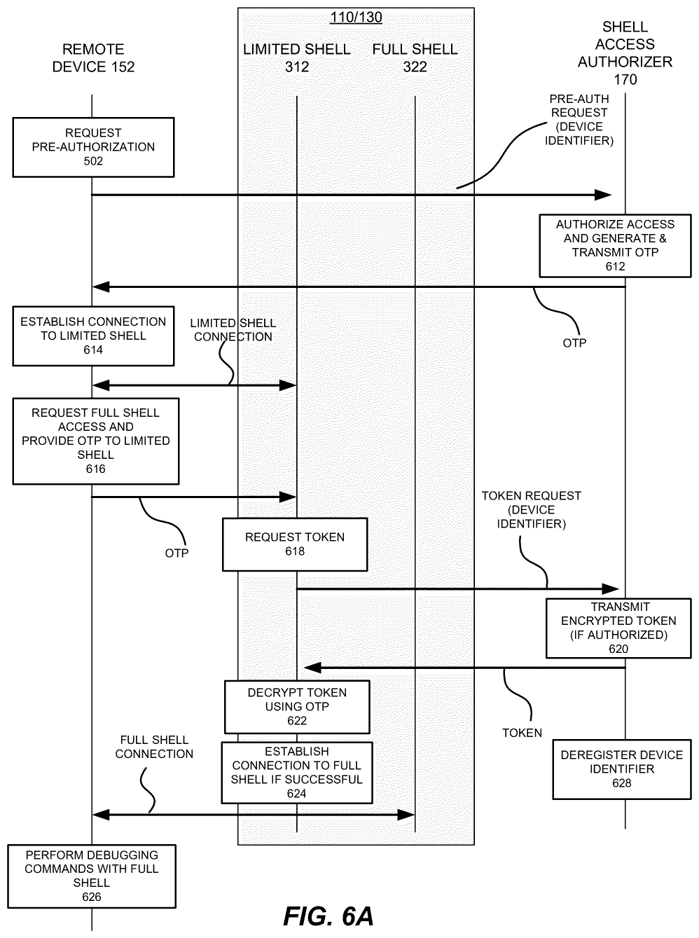

FIG. 5 is a communication diagram illustrating aspects related to registering a device with a shell access authorizer and generating authorization credentials, according to some embodiments of the present disclosure.

As seen in FIG. 5, as part of a troubleshooting or debugging workflow for a computer networking device 110/130, a user may submit a pre-authorization request that access be granted to the access-limited full command set shell program 322 that is installed on the computer networking device 110/130 (block 502). The pre-authorization request may include the serial number or other device identifier of the computer networking device 110/130. FIG. 5 shows the pre-authorization request originating from the remote device 152, which may be a computing device used to perform the debugging or troubleshooting of the client networking device 110/130. However, in some embodiments the pre-authorization request may originate from a different computing device than the computing device used to perform the debugging or troubleshooting of the client networking device 110/130.

The device registration and access validation service 344 may be used in deciding whether to validate access to the access-limited full command set shell program 322 that is installed on the computer networking device 110/130 (block 504). As discussed above, in some embodiments, information may be used in the decision-making process. If a decision is made that access may be granted to the access-limited full command set shell program 322 that is installed on the computer networking device 110/130, then the computer networking device 110/130 may be registered with the device registration and access validation service 344 (block 506). For example, the serial number or other device identifier of the computer networking device 110/130 may be stored in a database or data store accessible to the shell access authorizer 170.

Additionally, authorization credentials may be generated by the OTP generator 346 and the token generator 348 (blocks 508 and 510). As discussed above, the OTP generator 346 may generate an OTP, which may be an alphanumeric sequence of characters that secures or encrypts a token generated by the token generator 348. The token generated by the token generator 348 may include parameters (discussed above) associated with a debugging or troubleshooting session using the access-limited full command set shell program 322 that is installed on the computer networking device 110/130. In some embodiments, the parameters for the debugging or troubleshooting session using the access-limited full command set shell program 322 that is installed on the computer networking device 110/130 may be selected as part of the decision as to whether to grant access to the access-limited full command set shell program 322 (e.g., in block 504), and may be embedded in the token during the generation process (e.g., in block 510). After the OTP is generated, it may be provided to the user or device that requested the pre-authorization and/or registering of the computer networking device 110/130. The token may be associated with the serial number or other device identifier of the computer networking device 110/130 that is stored in the database or data store accessible to the shell access authorizer 170.

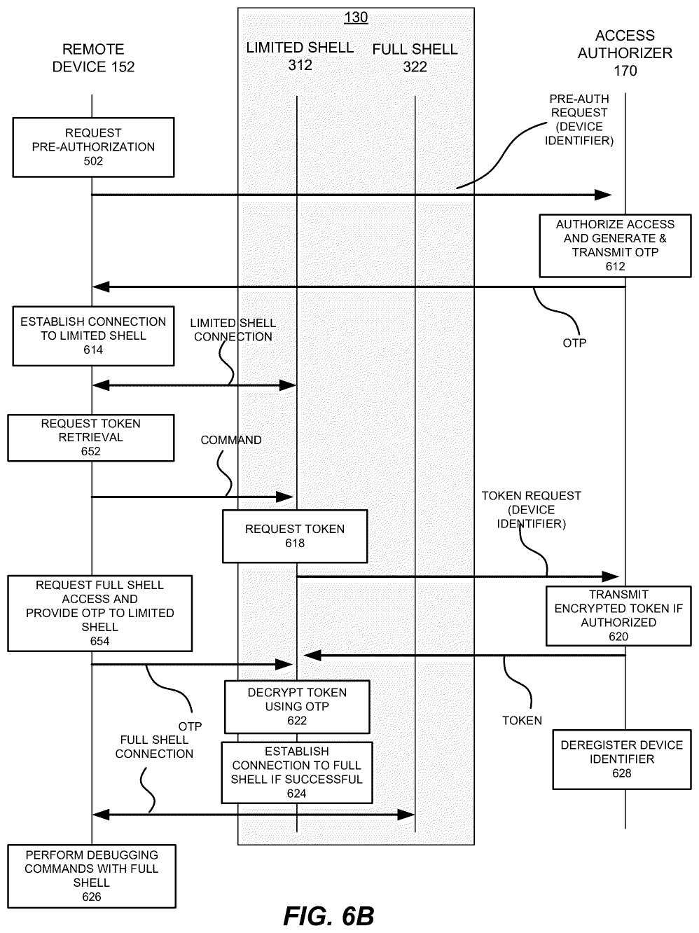

FIGS. 6A and 6B are communication diagrams illustrating aspects related to retrieving authorization credentials via a limited command set shell program to access an access-limited full command set shell program, according to some embodiments of the present disclosure. In FIG. 6A, a troubleshooting or debugging process of a computer networking device 110/130 may include a pre-authorization request to access an access-limited full command set shell program 322 that is installed on the computer networking device 110/130. The pre-authorization request may be similar to that discussed with reference to FIG. 5 (block 502). The shell access authorizer 170 may be used to authorize access to the access-limited full command set shell program 322 that is installed on the computer networking device 110/130 (block 612), which may include validating of the access, registering of the device identifier and generating of the authorization credentials discussed with reference to FIG. 5 (e.g., blocks 504, 506, 508, and 510 of FIG. 5). The debugging or troubleshooting user may receive the OTP generated by the shell access authorizer 170.

The debugging or troubleshooting user may then use the remote device 152 to establish a connection to the limited command set shell 312 that is installed on the computer networking device 110/130 (block 614). For example, the user may instantiate or connect to a process running on the computer networking device 110/130 that is configured to receive connection requests from computer devices such as the remote device 152 and provide access to the limited command set shell 312. To access the limited command set shell 312, the user may provide (via the remote device 152) authentication and/or authorization identifiers, such as a username or password that differs from the generated OTP. The debugging or troubleshooting user may then request access to the access-limited full command set shell 322 by invoking a process resident on the computer networking device 110/130 and accessible via the limited command set shell 312 (block 616). For example, the user may type in a “shell-access” command identifier or the like that identifies a shell-access command.

The shell-access command may then receive as input (e.g., as user input) the OTP. The shell-access command may then request the token from the shell access authorizer 170 (block 618). The shell-access command may provide, as part of a token request, a device identifier to the shell access authorizer 170. The shell access authorizer 170 may receive the token request and the device identifier and use the device identifier as a lookup value to determine whether the computer networking device 110/130 is registered with the device registration and access validation service 344. If the device identifier matches a value stored in a database or data store accessible to the shell access authorizer 170, then the shell access authorizer 170 may consider the request for the token received from the computer networking device 110/130 to be valid, and may provide in response thereto the previously generated token (block 620). On the other hand, if the device identifier does not match a value stored in the database or data store accessible to the shell access authorizer 170, then the shell access authorizer 170 may return an error message or other indicator that the computer networking device 110/130 is not registered with the device registration and access validation service 344. In some embodiments, and as described in greater detail below, the shell access authorizer 170 or a component thereof may determine whether the token is valid (e.g., the token has not expired) before providing the token to the computer networking device 110/130 and the shell-access command running on the computer networking device 110/130.

In some embodiments, once the token is provided to the computer networking device 110/130 and the shell-access command running on the computer networking device 110/130, the device identifier stored in a database or data store accessible to the shell access authorizer 170 may be removed, resulting in deregistering of the computer networking device 110/130 with the device registration and access validation service 344 (block 628). Additionally, or alternatively, the token may be deleted from a memory that is accessible to the shell access authorizer 170, or the token may be indicated as no longer active or accessible. This may prevent unauthorized access to the access-limited full command set shell program 322 that is installed on the computer networking device 110/130. Subsequent troubleshooting and debugging sessions may require re-registration of the computer networking device 110/130 with the device registration and access validation service 344.

Once the token is received from the shell access authorizer 170, the computer networking device 110/130 (e.g., the shell-access command) may attempt to decrypt the token using the OTP provided as input (block 622). If the OTP successfully decrypts the token, then the shell-access command may decide that the attempt to access the access-limited full command set shell 322 is both authorized (e.g., by the presence of the token) and authenticated (e.g., by the presence of the OTP that decrypts the token). In response to deciding or determining that the attempt to access the access-limited full command set shell 322 is authorized and authenticated, the shell-access command may provide access to the access-limited full command set shell 322 according to the parameters defined by the token (block 624). The remote device 152 and the access-limited full command set shell 322 may thus be directed to establish a session via which the debugging or troubleshooting user may perform debugging or troubleshooting commands (block 626).

In some embodiments, the shell-access command may read the parameters of the token and take steps or actions to conform the established session with the access-limited full command set shell 322 with the parameters of the token, and revert the session to the limited command set shell 312 if a reversion trigger is detected. For example, the shell-access command may instantiate a timer if the token has a duration parameter, compare the present date and time with an expiry parameter of the token, count a number of debugging or troubleshooting commands, etc. A reversion trigger may be communicated based on, e.g., an expiration of the timer, detection that the token has expired, or detecting that a count of commands exceeds that provided by the token. Additionally, or alternatively, a reversion trigger may be received from the remote device 152, e.g., when the debugging or troubleshooting user has completed their debugging or troubleshooting work (successfully or unsuccessfully). This may prevent unauthorized access to the access-limited full command set shell program 322 that is installed on the computer networking device 110/130, or access that exceeds the defined parameters of the token.

FIG. 6B also depicts a troubleshooting or debugging process of a computer networking device 110/130 that is similar in some respects to the troubleshooting or debugging process of FIG. 6A. However, in some embodiments, after the remote device 152 establishes a connection to the limited command set shell 312, the remote device may be operated to request the token from the shell access authorizer 170 via a separate command from the shell accessing command. For example, the debugging or troubleshooting user may invoke a retrieve-token command (block 652) that requests the token from the shell access authorizer 170. Once the token has been successfully retrieved, the debugging or troubleshooting user may then invoke the shell-access command. In other words, FIG. 6A shows a one-command process, while FIG. 6B shows a two-command process. The process of FIG. 6B may prevent inadvertent expiration of the OTP in instances where the shell access authorizer 170 has not completed of the device registration and validation operations and/or token generation operations.

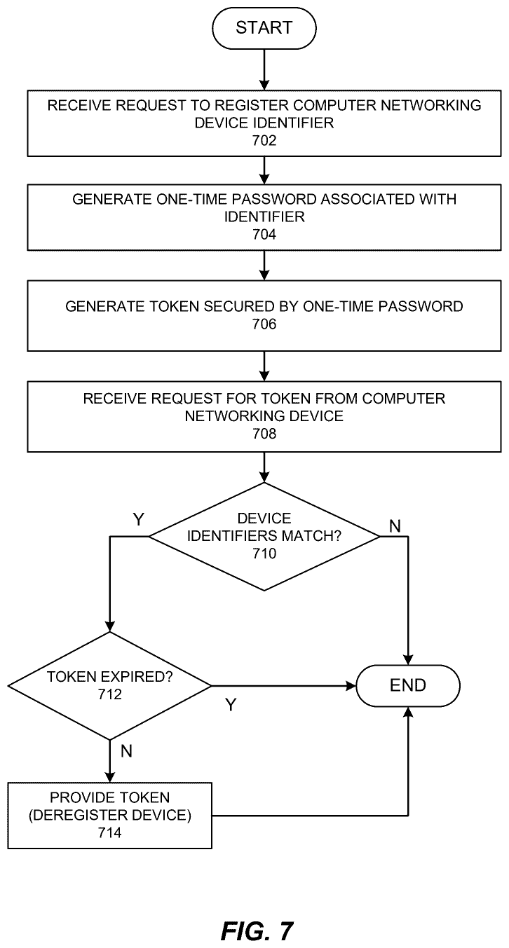

FIG. 7 is a flow diagram illustrating aspects related to registering a computer networking device with a shell access authorizer and generating and providing authorization credentials for the computer networking device, according to some embodiments of the present disclosure. As seen in FIG. 7, in some embodiments, the shell access authorizer 170 and/or components thereof may receive a request to register a computer networking device 110/130, and/or may receive a request to register a device identifier of the computer networking device 110/130 (block 702). In response thereto, an OTP associated with the device identifier may be generated (block 704). A token used to authorize access to an access-limited full command set shell may be generated, and the OTP may be used to encrypt or otherwise secure the token (block 706). The token may be associated with the device identifier of the computer networking device 110/130. Subsequently, a request for the token may be received from a computer networking device 110/130 (block 708). The request for the token may include a device identifier, which is compared with previously-stored device identifiers (block 710). If a match between the device identifier of a registered computer networking device 110/130 matches the device identifier received with the request for the token (“Y” branch from block 710), then the token may be examined to determine whether the token is still valid and/or has not expired (block 712). If the token is still valid and has not expired (“N” branch from block 712), then the token may be provided to the requesting computer networking device 110/130 (block 714). In some embodiments, and subsequent to providing the token to the requesting computer networking device 110/130, the token may be deleted and/or an identifier of the computer networking device 110/130 may be removed from the device registration and access validation service 344. If there is no match between the device identifiers of registered computer networking devices 110/130 and the device identifier received with the request for the token (“N” branch from block 710), or if there is a match but the token is not valid or has expired (“Y” branch from block 712), then no token is provided in response to the request.

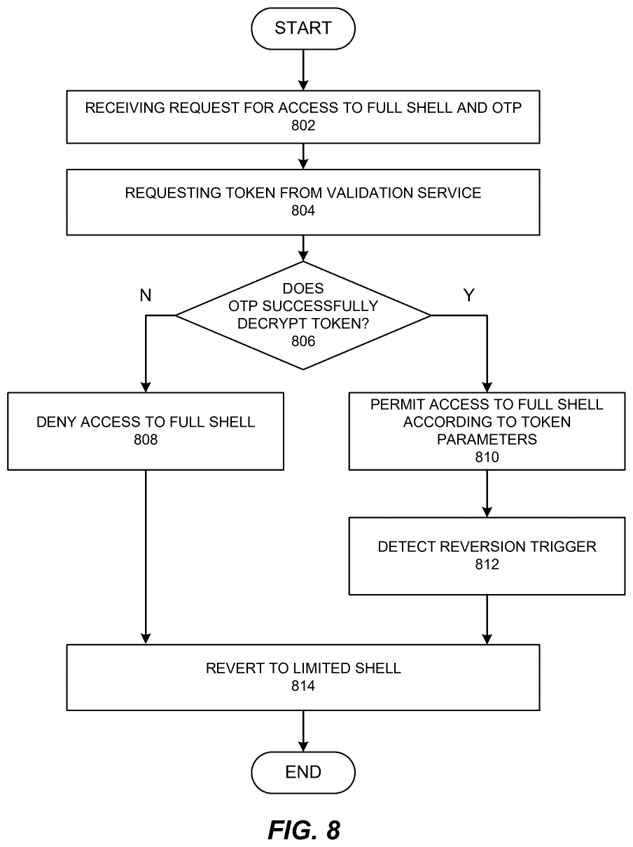

FIG. 8 is a flow diagram illustrating aspects related to retrieving authorization credentials via a limited command set shell program to access an access-limited full command set shell program, according to some embodiments of the present disclosure. As seen in FIG. 8, in some embodiments, a limited command set shell 312 operating on a computer networking device 110/130 may receive a request (e.g., via invocation of a shell-access program installed on the computer networking device 110/130) to access an access-limited full command set shell 322 that is installed on the computer networking device 110/130 (block 802). The request may be associated with an OTP that is provided as input. In response to the request, or in response to a different command, the computer networking device 110/130 may transmit a request for a token to a shell access authorizer 170 or a component thereof (block 804). The request for the token may include a serial number or other device identifier of the computer networking device 110/130. In response to the request for the token, the computer networking device 110/130 may receive a token from the shell access authorizer 170. The computer networking device 110/130 may attempt to use the OTP to decrypt the received token (block 806). If the OTP does not decrypt the received token (“N” branch from block 806), then the computer networking device 110/130 may deny access to the access-limited full command set shell 322 (block 808) and revert to the limited command set shell 312 (block 814). On the other hand, if the OTP does decrypt the received token (“Y” branch from block 806), then the computer networking device 110/130 may permit access to the access-limited full command set shell 322 installed on the computer networking device 110/130 (block 810). The access may be permitted according to the parameters of the token. While access to the access-limited full command set shell 322 installed on the computer networking device 110/130 is being provided, a reversion trigger may be detected (block 812). In response to the reversion trigger, the computer networking device 110/130 may revert to the limited command set shell 312 (block 814). After reversion to the limited command set shell 312, any token stored at the computer networking device 110/130 may be deleted.

FIG. 9 is a block diagram illustrating an electronic device 1100 in accordance with some embodiments. The electronic device 1100 may be, for example, one of the access points 110 or one of the client devices 120 illustrated in FIG. 2, the network switches 130 illustrated in FIGS. 1-4, the controller 140 of FIGS. 1 and 3, the remote device 152 of FIG. 1, and other devices. The electronic device 1100 includes a processing subsystem 1110, a memory subsystem 1112, and a networking subsystem 1114. Processing subsystem 1110 includes one or more devices configured to perform computational operations. Memory subsystem 1112 includes one or more devices for storing data and/or instructions. In some embodiments, the instructions may include an operating system and one or more program modules which may be executed by processing subsystem 1110.

Networking subsystem 1114 includes one or more devices configured to couple to and communicate on a wired and/or wireless network (i.e., to perform network operations), including: control logic 1116, an interface circuit 1118 and one or more antennas 1120 (or antenna elements). While FIG. 9 includes an antenna 1120, in some embodiments electronic device 1100 includes one or more nodes, such as nodes 1108, e.g., a connector, which can be coupled to one or more antennas 1120 that are external to the electronic device 1100. Thus, electronic device 1100 may or may not include the one or more antennas 1120. Networking subsystem 1114 includes at least a networking system based on the standards described in IEEE 802.11 (e.g., a Wi-Fi networking system).

Networking subsystem 1114 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1100 may use the mechanisms in networking subsystem 1114 for performing simple wireless communication between the electronic devices, e.g., transmitting frames and/or scanning for frames transmitted by other electronic devices.

Processing subsystem 1110, memory subsystem 1112, and networking subsystem 1114 are coupled together using bus 1128. Bus 1128 may include an electrical, optical, and/or electro-optical connection that the subsystems can use to communicate commands and data among one another.

Electronic device 1100 can be (or can be included in) any electronic device with at least one network interface. For example, electronic device 1100 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

The operations performed in the communication techniques according to embodiments of the present disclosure may be implemented in hardware or software, and in a wide variety of configurations and architectures. For example, at least some of the operations in the communication techniques may be implemented using program instructions 1122, operating system 1124 (such as a driver for interface circuit 1118) or in firmware in interface circuit 1118. Alternatively or additionally, at least some of the operations in the communication techniques may be implemented in a physical layer, such as hardware in interface circuit 1118.

Embodiments of the present disclosure have been described above with reference to the accompanying drawings, in which embodiments of the disclosure are shown. The inventive concepts may, however, be embodied in many different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

What is claimed is:

1. A method comprising:
receiving a request to register a first device identifier that is associated with a computer networking device;
generating a token;
associating the generated token with the first device identifier;
generating a one-time password that secures the generated token;
transmitting the generated one-time password that secures the generated token;
receiving a request for the token from the computer networking device, the request including a second device identifier, the second device identifier identifying the computer networking device;
comparing the second device identifier with the first device identifier; and
providing the token to the computer networking device if the second device identifier matches the first device identifier.

2. The method of claim 1, wherein the token is configured to provide access to an access-limited shell program installed on the computer networking device.

3. The method of claim 1, wherein the token has an expiration value.

4. The method of claim 3, wherein providing the token to the computer networking device if the second device identifier matches the first device identifier further comprises providing the token to the computer networking device if the token has not expired.

5. The method of claim 1, further comprising:
deleting the token after providing the token to the computer networking device.

6. The method of claim 1, wherein the computer networking device is a switch.

7. The method of claim 1, wherein the computer networking device is an access point.

8. A method comprising:
receiving, at a limited command set shell program installed on a computer networking device, a request to access an access-limited shell program also installed on the computer networking device;
receiving a one-time password;
receiving a token in response to transmitting a request for the token to a shell access authorizer; and
providing access to the access-limited shell program if the one-time password decrypts the token.

9. The method of claim 8, further comprising:
detecting a reversion trigger; and
reverting to the limited command set shell program based on the detection of the reversion trigger.

10. The method of claim 9, wherein the token indicates a time after which the token expires, and wherein the reversion trigger is based on the token expiring.

11. The method of claim 9, wherein the token indicates a duration for which the token is valid, and wherein the reversion trigger is based on a time duration for which access is provided to the access-limited shell program exceeding the time duration.

12. The method of claim 9, further comprising:
deleting the token after reverting to the limited command set shell program.

13. The method of claim 8, wherein the computer networking device is a switch.

14. The method of claim 8, wherein the access-limited shell program is configured to provide access to a command, and wherein the limited command set shell program is configured to block access to the command.

15. The method of claim 14, wherein the command is an operating system command.

16. A computer networking device, comprising a processor and memory storing instructions that, when executed by the processor, cause the processor to perform operations comprising:
receiving, at a limited command set shell program installed on the computer networking device, a request to access an access-limited shell program also installed on the computer networking device;
receiving a one-time password;
receiving a token in response to transmitting a request for the token to a shell access authorizer; and
providing access to the access-limited shell program if the one-time password decrypts the token.

17. The computer networking device of claim 16, wherein the access to the access-limited shell program is provided to a remote device.

18. The computer networking device of claim 16, wherein the computer networking device is a switch.

19. The computer networking device of claim 16, wherein the access-limited shell program is configured to provide access to a command, and wherein the limited command set shell program is configured to block access to the command.

20. The computer networking device of claim 16, wherein the computer networking device is configured to provide access to the access-limited shell program for a predetermined duration.
